(19) United States
(12) Patent Application Publication
(10) Pub. No.: US 2024/0397908 A1
(43) Pub. Date: Dec. 5, 2024

(54) PET FOOD BOWL

(71) Applicant: The Kyjen Company, LLC, Centennial, CO (US)

(72) Inventors: Graham Geil Wilson, Denver, CO (US); Nina Ingela Ottosson, Karlskoga (SE); Danielle Salyer, Denver, CO (US)

(21) Appl. No.: 18/204,563

(22) Filed: Jun. 1, 2023

(51) Int. Cl. A01K 5/01

(52) U.S. Cl. CPC A01K 5/0114

(57) ABSTRACT

A pet food bowl includes a base and a dispenser secured to the base. The dispenser includes a barrel having a first open end and a second open end. The dispenser also includes a first cap couplable to the first open end of the barrel and a second cap couplable to the second open end of the barrel. The first cap and the second cap of the dispenser are configured to secure the dispenser to the base.

### BACKGROUND OF THE DISCLOSURE

### Field of the Disclosure

The disclosure relates generally to a pet food bowl, and more specifically, to a pet food bowl configured to dispense food with a dispenser rotatable by a pet.

### Brief Description of Related Technology

Generally, a wide variety of pet food bowls are available to keep pets engaged with eating as well as devices to slow down eating for pets who eat too fast. For example, these “slow feeders” include pet food bowls, pet feeding toys, pet feeding mats, and the like. However, in addition to keeping pets from eating too fast, it is important to provide pets with mental stimulus in order to improve their overall health and behavior and to keep the pets engaged with the activity of eating. Accordingly, there is a need for a pet food bowl that slows a pet's consumption of food while keeping the activity of eating fun and engaging.

### SUMMARY OF THE DISCLOSURE

In accordance with one aspect of the present disclosure, a pet food bowl includes a base and a dispenser secured to the base. The dispenser includes a barrel having a first open end and a second open end. The dispenser also includes a first cap couplable to the first open end of the barrel and a second cap couplable to the second open end of the barrel. The first cap and the second cap of the dispenser are configured to secure the dispenser to the base.

In accordance with another aspect of the present disclosure, a pet food bowl includes a base and a dispenser. The base includes a basin having baffles. The base also includes an upwardly extending portion, where the dispenser is secured to the upwardly extending portion.

### BRIEF DESCRIPTION OF THE FIGURES

For a more complete understanding of the disclosure, reference should be made to the following detailed description and accompanying drawing figures, in which like reference numerals identify like elements in the figures.

FIG. 1 illustrates a pet food bowl with a rotatable dispenser in accordance with one example of the present disclosure.

FIG. 2 illustrates a top view of the pet food bowl of FIG. 1.

FIG. 3 illustrates a front view of the pet food bowl of FIG. 1.

FIG. 4A illustrates a left side view of the pet food bowl of FIG. 1.

FIG. 4B illustrates a right side view of the pet food bowl of FIG. 1.

FIG. 5 illustrates an exploded view of the dispenser and end caps of the pet food bowl of FIG. 1.

FIG. 6 illustrates an exploded view of two halves of the dispenser of FIG. 5.

FIG. 7 illustrates an exploded view of the pet food bowl of FIG. 1.

### DETAILED DESCRIPTION OF THE DISCLOSURE

The present disclosure is provided to solve the above-mentioned problems in the Background of the Disclosure section. Specifically, the present disclosure provides a pet food bowl designed to extend mealtime and fight boredom by making mealtime fun and engaging for a pet. The disclosed pet food bowl is designed to engage and exercise a pet's mind by replacing a standard food bowl with a food bowl that is both a puzzle and feeder all in one. The disclosed pet food bowl keeps pets engaged and busy by encouraging pets to work on their problem-solving skills. The disclosed pet food bowl provides mental stimulation and exercise that alleviates boredom and extends mealtime, giving pets the mental stimulation they need.

As described herein, the disclosed pet food bowl is configured to dispense food at a slower pace with a dispenser that is rotatable by a pet. The disclosed pet food bowl has a base portion to collect dispensed food from a rotatable dispenser that is connected between two sides of the base. One of the main purposes of the disclosed pet food bowl is to extend feeding for pets. By adding a rotatable dispenser to a base configured to collect the food dispensed slowly by the dispenser, a pet may be engaged for a long time while eating at a healthier pace. Additionally, the base portion may contain a maze pattern designed to lengthen feeding and play times. The maze pattern may be made up of any number of baffles or protrusions that aids in slowing the pace of food consumption while providing additional mental stimulation.

Referring generally to the Figures, a pet food bowl according to the present disclosure includes a base and a dispenser. The dispenser includes a barrel with two open ends on opposite sides of the barrel for adding food or treats to the barrel. The dispenser includes caps (e.g., end or side caps) designed to fit onto the two open ends of the barrel. The two caps of the dispenser rotatably secure the dispenser to the base. The dispenser is free to rotate allowing food to be dispensed from a plurality of openings of the barrel into the base.

A pet food bowl in accordance with the present disclosure may be configured to engage a pet for a duration of time while the pet attempts to get food or treats out of the dispenser and into the base. A pet may manipulate the dispenser attempting to get food or treats out of the dispenser and into the base of the pet food bowl using, for example, their paws and/or mouth to rotate or spin the dispenser. The dispenser may include ridges, grooves, or other traction devices or gripping mechanisms to allow the pet to more easily spin or rotate the dispenser. As the pet manipulates the dispenser, the dispenser may rotate, thus allowing food and/or treats to fall out of the openings of the barrel and into the base of the food bowl.

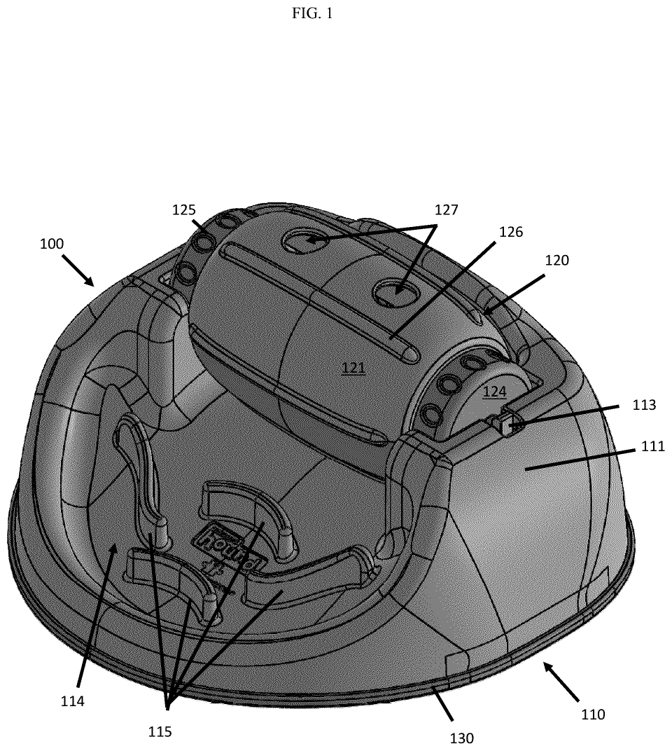

Referring to the Figures, FIGS. 1-7 show a pet food bowl 100 in accordance with one example of the present disclosure. The relative dimensions shown in any of the figures are exemplary only, and other sizes and shapes may be used. FIG. 1 shows a pet food bowl 100 for interaction of a pet animal. FIG. 1 shows an isometric view of the pet food bowl 100. The pet food bowl 100 includes a base 110 and a dispenser 120 secured to the base 110. As shown in FIG. 1, the base 110 includes a lower portion or basin 114 and an upwardly extending portion 111. The basin 114 may be located at a front side of the base 110 and the upwardly extending portion 111 may be located on a back side or rear of the base 110. Other configurations are possible. As shown in FIG. 1, the basin 114 includes baffles 115 (i.e., small walls, panels, or upwardly protruding sections) that form a maze pattern to allow the dispensed food to fall and collect in a more engaging manner, while also extending feeding times. Other types of barriers or partitions, such as pegs, domes, blocks, and the like may also be used to interrupt the flow of food as it falls into the basin 114 from the dispenser 120.

The dispenser 120 is removably connected to the upwardly extending portion 111 of the base 110. The upwardly extending portion 111 includes receptacles 112 on opposite sides for placement of respective ends of the dispenser 120, as will be described in more detail below. In this regard, the dispenser 120 is disposed within or between portions of the upwardly extending portion 111. In one example, the upwardly extending portion 111 extends around a segment, such as half, of the periphery of the base 110. In another example, the upwardly extending portion 111 may include multiple upwardly extending portions where each portion may be located in the middle or toward the center of the base 110 along the outer periphery of the base 110.

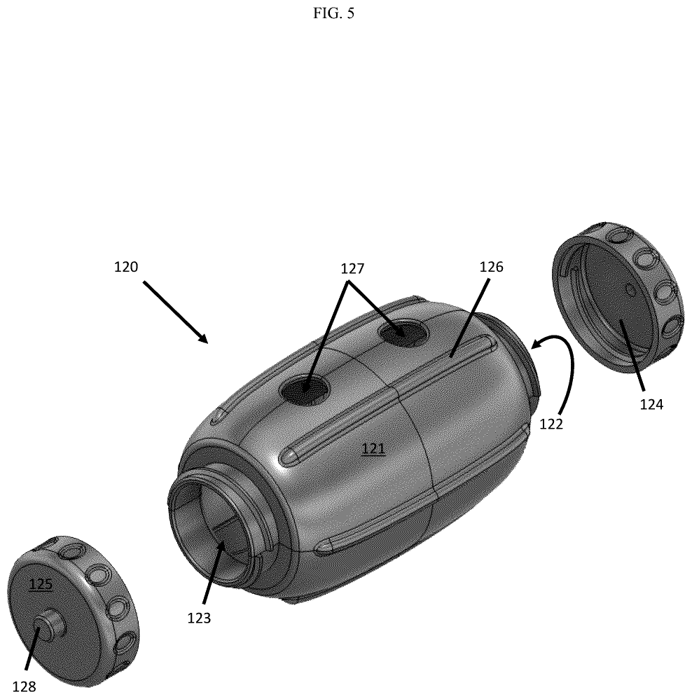

The dispenser 120 includes a barrel 121 having two open ends and corresponding caps or covers for each respective end (the terms “caps,” “end caps,” and “side caps” are used interchangeably herein). As shown in FIG. 5, the barrel 121 has a first open end 122 and a second open end 123 that allows for filling, emptying, and/or cleaning of the barrel 121. The barrel 121 is designed and configured to fit enough food for a full meal for a pet, or to include a smaller number of treats. The dispenser 120 also includes a first cap 124 couplable to the first open end 122 of the barrel 121 and a second cap 125 couplable to the second open end 123 of the barrel 121. The first and second caps 124, 125 are configured to mechanically lock or otherwise engage with the first and second open ends 122, 123, respectively. As shown in FIGS. 5-7, the first and second caps 124, 125 and corresponding first and second open ends 122, 123 each include screw threads and corresponding grooves (i.e., internal and external threads) to allow the caps 124, 125 to be screwed onto the open ends 122, 123. Other types of mating mechanisms are possible, such as clasps, magnets, and/or other mechanical locking devices. As shown in the figures, an exterior surface of the barrel 121 of the dispenser 120 includes ridges or grooves 126 to allow a pet to more easily engage their paws or mouths with the barrel 121 to manipulate the dispenser 120. The barrel 121 of the dispenser 120 also includes a plurality of openings 127 to allow the pet food inside the barrel 121 to be dispensed when the dispenser 120 is rotated.

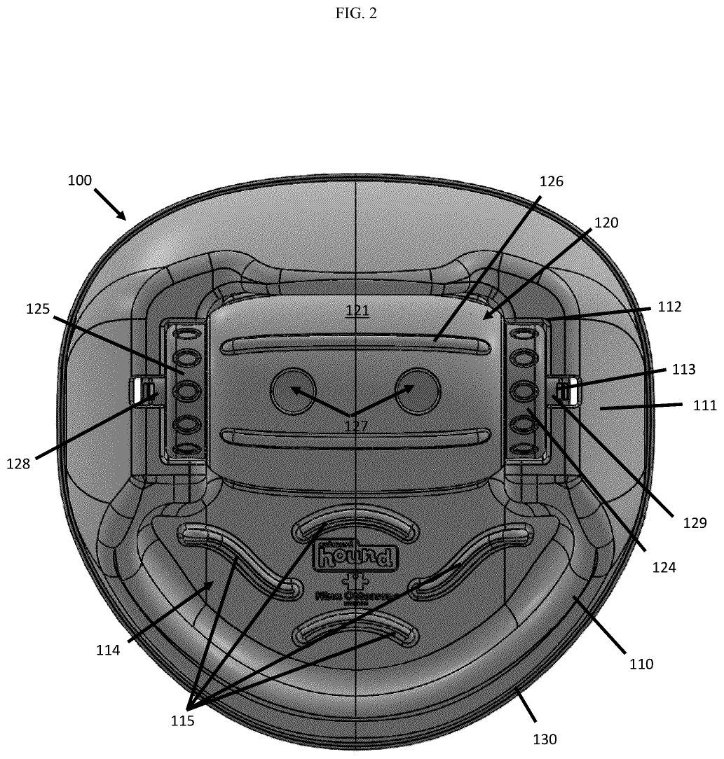

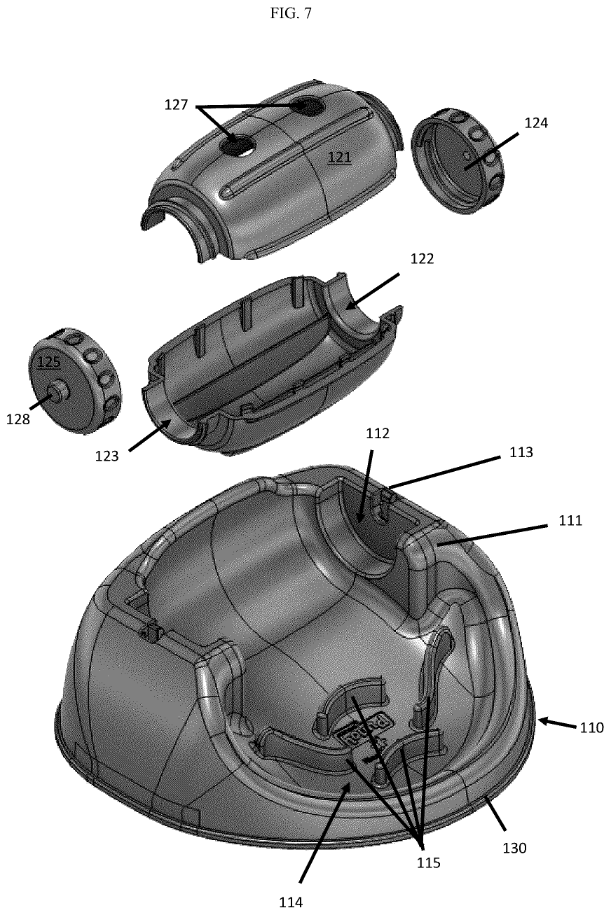

FIG. 2 shows a top view of the pet food bowl 100 with the rotatable dispenser 120. On each exterior surface of the first and second caps 124, 125 is a protrusion 128, 129. The first and second caps 124, 125 are configured to fit into corresponding receptacles 112 of the base 110. The receptacles 112 include a locking mechanism 113 configured to mechanically lock the dispenser 120 to the base 110 in a rotatable fashion. As shown in FIGS. 5-7, the protrusions 128, 129 are small cylindrically shaped protrusions extending away from the exterior surface of the caps 124, 125. The locking mechanisms 113 are sized and shaped to correspond to the size and shape of the protrusions 128, 129. Similarly, the receptacles 112 in the upwardly extending portion 111 of the base 110 are sized and shaped to correspond to the first and second caps 124, 125. As shown in FIG. 7, the receptacles 112 are semi-circular shaped depressions or cutouts in the upwardly extending portion 111 of the base 110 designed to receive at least a portion of the first and second caps 124, 125, respectively. The locking mechanism 113 may be any sort of locking mechanism 113, such as press fit fasteners, snaps, threads, magnets, or combinations thereof that allow the protrusions 128, 129 to rotate freely when engaged with the locking mechanisms 113. For example, as shown in FIG. 7, the locking mechanisms 113 may be a snap-fit fastener, such as a cantilever or torsional snap-fit fastener having a lever portion and a protruding edge. Referring to one side only for simplicity's sake, as the protrusion 128 of the cap 125 engages the locking mechanism 113, the protrusion 128 contacts the protruding edge of the snap-fit fastener, which causes the lever portion to deflect, allowing the protrusion 128 to move into the corresponding space below the protruding edge of the snap-fit fastener. Once the protrusion 128 moves past the protruding edge, the lever portion snaps back to its original location and the protruding edge prevents the protrusion 128 from being removed from the locking mechanism 113. To disengage the protrusion 128 from the locking mechanism 113, the lever portion is forced to its deflected position. In the deflected position, the protruding edge is moved away from the protrusion 128, thus allowing the protrusion 128 to move past the protruding edge of the snap-fit fastener and become disengaged with the locking mechanism 113.

Once the barrel 121 of the dispenser 120 is filled with food or treats, the first and second caps 124, 125 are secured to the open ends 122, 123 of the barrel 121. The dispenser 120 is then secured to the base 110 by placing the first and second caps 124, 125 into the corresponding receptacles 112 in the upwardly extending portion 111 of the base 110. The protrusions 128, 129 on the exterior surfaces of the first and second caps 124, 125 rotatably engage with the corresponding locking mechanisms 113 of the receptacles 112, as described above, thus securing the dispenser 120 to the base 110 in a rotatable fashion. Once rotatably secured to the upwardly extending portion 111 of the base 110, the dispenser 120 is free to rotate within the receptacles 112. To remove the dispenser 120 from the base 110, the locking mechanisms 113 are disengaged as described above, thereby allowing the protrusions 128, 129 and first and second caps 124, 125 to be removed from the corresponding receptacles 112 in the upwardly extending portion 111 of the base 110.

Referring back to FIG. 2, the base 110 of the disclosed pet food bowl 100 may also include an anti- or non-slip/skid coating or layer 130 disposed around a lower outer periphery of the base 110. The anti- or non-slip/skid coating or layer 130 prevents the pet food bowl 100 from sliding across the floor as a pet interacts with the dispenser 120.

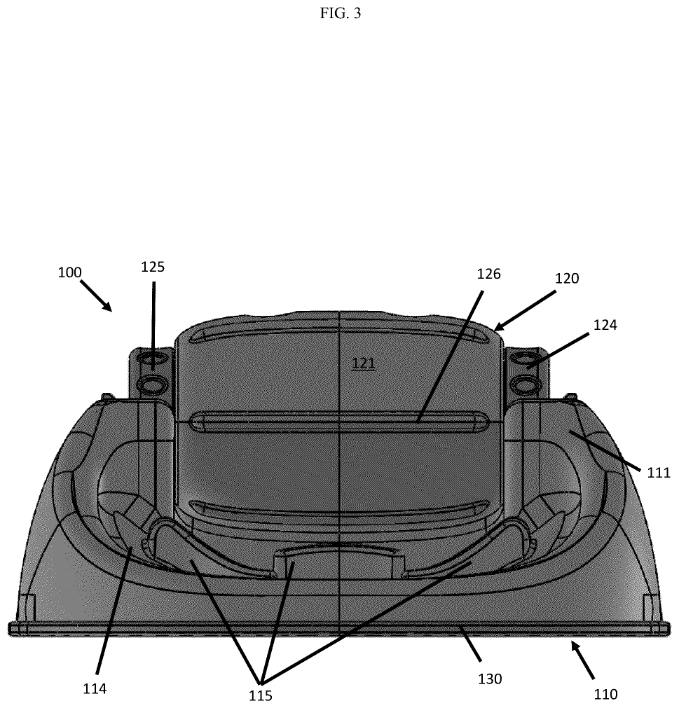

FIG. 3 illustrates a front view of the pet food bowl 100 according to one example of the present disclosure. As shown in FIG. 3, the barrel 121 has ridges 126 extending outwardly away from the exterior surface of the barrel 121 (i.e., perpendicular to the axis of rotation of the dispenser 120). In some examples, instead of ridges 126 the barrel 121 may include grooves extending inwardly into the surface of the barrel 121. Having ridges 126 or grooves on the exterior surface of the barrel 121 allows a pet to be able to manipulate the dispenser 120 more easily than if the exterior surface of the barrel 121 was smooth.

As illustrated in FIG. 3, the baffles 115 are raised from (i.e., extend upwardly and away from the surface of) the basin 114, causing the dispensed food to be deflected off the baffles 115 in different directions of the basin 114. As shown in FIGS. 1-3 and 7, the basin 114 of the base 110 of the disclosed pet bowl 100 includes four separate arc or curved shaped baffles 115 spaced apart from one another and arranged such that as food is dispensed from the dispenser 120, the food slides down into the basin 114 and is deflected by the baffles 115, thus causing the food to take different paths to the bottom of the basin 114. However, the present disclosure is not limited thereto and the shape, size, number, and arrangement of baffles 115 may vary.

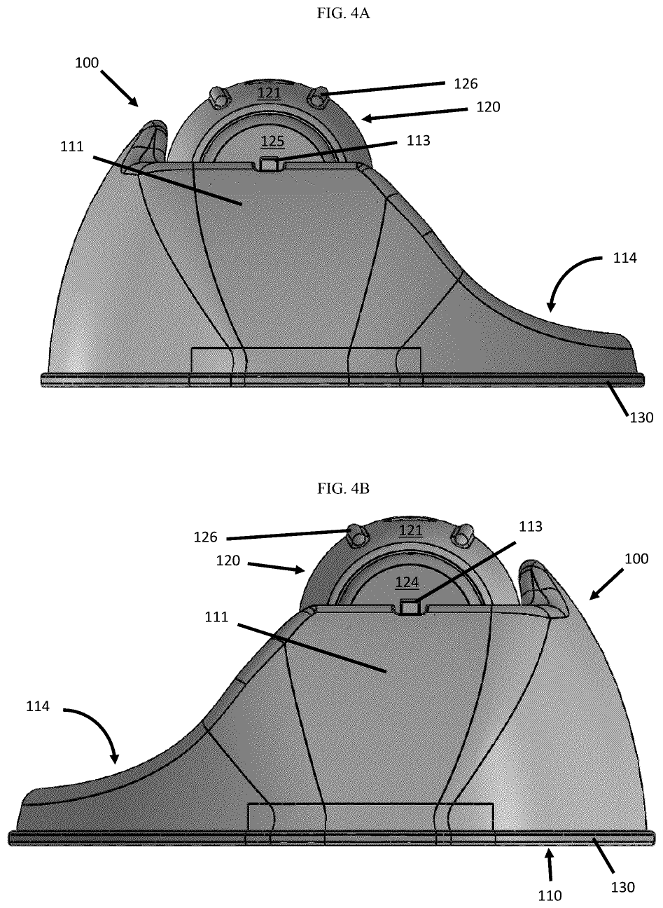

FIGS. 4A and 4B show the side views of the disclosed pet food bowl 100 according to one example of the present disclosure. As shown in FIGS. 4A and 4B, the upwardly extending portion 111 of the base 110 tapers downwardly towards the basin 114. As described above, the upwardly extending portion 111 of the base 110 may comprise at least half of the base 110, extending from one end (i.e., rear) of the base 110 and wrapping around to each side of the base 110. In another example, each side of the base 110 may have a separate upwardly extending portion 111 that tapers in both directions toward the front and rear of the bowl 100. In this case, food or treats dispensed from the dispenser 120 may thus fall in either direction to two separate basins 114, one at the front and one at the rear of the bowl 100. However, the present disclosure is not limited thereto, and the shape, size, and number of the upwardly extending portions 111 may vary.

As further illustrated by FIGS. 4A and 4B, the exterior of the base 110 may taper inward toward the center of the base 110 to allow a more balanced and sturdier design for the pet food bowl 100. While the shape of the base 110 tapers in a curved manner, the base 110 may extend and taper in a variety of shapes and directions, including straight up, diagonal, curved, sloped, wavy, or any combination thereof.

FIG. 5 shows an exploded view of the dispenser 120 of the disclosed pet food bowl 100 according to one example of the present disclosure. Included in the exploded view of the dispenser 120 are the barrel 121 and the first and second end caps 124, 125. The barrel 121 includes a plurality of holes or openings 127 that allows the pet food or treats to be dispensed when the dispenser 120 is rotated. As shown in FIG. 5, the barrel 121 has a first and second open end 122, 123 on each end of the barrel 121 that allows for filling, emptying, or cleaning of the barrel 121. FIG. 5 also illustrates more clearly the first and second end caps 124, 125 and the protrusion 128 in the center of second end cap 125. As shown in FIG. 5, the protrusion 128 extending from the exterior of the second end cap 125 is circular shaped to allow for rotation of the barrel 121 in the receptacles 112. The first and second open ends 122, 123 and corresponding end caps 124, 125 are also illustrated as being circular shaped. Similarly, the barrel 121 is shown as cylindrically shaped. However, the present disclosure is not limited thereto, and the shape of the components shown in FIG. 5 may vary.

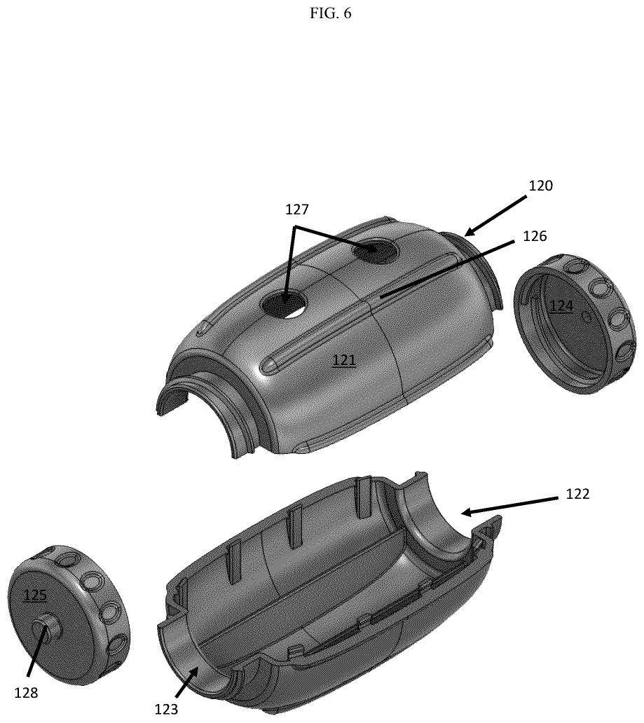

FIG. 6 shows another exploded view of the dispenser 120 of the disclosed pet food bowl 100 according to one example of the present disclosure. However, in FIG. 6 the two halves of the barrel 121 are shown separately. The two halves of the barrel 121 can be separated to allow for easier cleaning. However, in another example, the barrel 121 may be one integral piece. As discussed above, the barrel 121 of the dispenser 120 also includes a plurality of openings 127 to allow the pet food inside the barrel 121 to be dispensed when the dispenser 120 is rotated. As shown in FIG. 6, the barrel 121 includes two circular shaped openings 127 adjacent one another on the same side (i.e., portion of exterior surface) of the barrel 121. However, the present disclosure is not limited thereto and the shape, size, and number of the plurality of openings 127 may vary. The size, shape, and number of openings 127 affect the manner in which the food or treats inside the barrel 121 are dispensed. For instance, having one small opening in the barrel 121 allows less food to be dispensed, making it more difficult for a pet to receive the food from the dispenser 120, while having many, large openings in the barrel 121 allows the food to be dispensed more rapidly.

FIG. 7 illustrates an exploded view of the disclosed pet food bowl 100 according to one example of the present disclosure. As described above, FIG. 7 illustrates the simi-circular shape of the receptacles 112 where the first and second end caps 124, 125 nest within, as well as the locking mechanisms 113 configured to rotatably engage with the protrusions 128, 129 extending from the first and second end caps 124, 125. In this regard, the first cap 124 and the second cap 125 are removably connectable to the receptacles 112 of the upwardly extending portion 111 of the base 110.

The base 110 may be made of polypropylene (PP). The anti-skid coating or layer 130 may be made of a thermoplastic elastomer (TPE). The barrel 121 may be made of acrylonitrile butadiene styrene (ABS). The first and second end caps 124, 125 may be made of PP. One or more of the base 110, the dispenser 120, and the end caps 124, 125 may be comprised of styrenic block copolymers, thermoplastic polyolefinelastomers, thermoplastic vulcanizates, thermoplastic polyurethanes, thermoplastic copolyester, thermoplastic polyamides, or the like, and be free of Bisphenol A (BPA), lead, and phthalate. In other examples, one or more of the base 110, the dispenser 120, and the end caps 124, 125 may be comprised of thermoplastic rubber (TPR), thermoplastic polyurethane (TPU), polyvinyl chloride (PVC), rubber, low density polyethylene (LDPE), or high density polyethylene (HDPE). Other suitable materials, now known or later developed, may also be used.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clarity of understanding only, and no unnecessary limitations should be understood therefrom, as modifications within the scope of the invention may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet food bowl, comprising:
a base; and
a dispenser secured to the base, the dispenser comprising:
a barrel having a first open end and a second open end; and
a first cap couplable to the first open end of the barrel and a second cap couplable to the second open end of the barrel,
wherein the first cap and the second cap of the dispenser are configured to secure the dispenser to the base.

2. The pet food bowl of claim 1, wherein an exterior surface of the barrel of the dispenser includes ridges or grooves.

3. The pet food bowl of claim 1, wherein the barrel of the dispenser includes a plurality of openings.

4. The pet food bowl of claim 1, wherein the first cap and the second cap each include a protrusion on an outer surface thereof.

5. The pet food bowl of claim 1, wherein the first cap and the second cap are couplable to the first open end of the barrel and the second open end of the barrel, respectively, via a clasp, magnet, or mechanical locking device.

6. The pet food bowl of claim 1, wherein the base includes an upwardly extending portion.

7. The pet food bowl of claim 6, wherein the first cap and the second cap of the dispenser secure the dispenser to the base at the upwardly extending portion of the base.

8. The pet food bowl of claim 6, wherein the upwardly extending portion of the base includes receptacles.

9. The pet food bowl of claim 8, wherein the first cap and the second cap are removably connectable to the receptacles of the upwardly extending portion of the base.

10. The pet food bowl of claim 8, wherein the first cap and the second cap each include a protrusion on an outer surface thereof, and wherein the receptacles of the upwardly extending portion of the base include a locking mechanism to secure the protrusions of the first cap and the second cap to the receptacles.

11. The pet food bowl of claim 1, wherein the base includes a basin.

12. The pet food bowl of claim 11, wherein the basin of the base includes baffles.

13. A pet food bowl, comprising:
a base comprising:
a basin comprising baffles; and
an upwardly extending portion; and
a dispenser;
wherein the dispenser is secured to the upwardly extending portion.

14. The pet food bowl of claim 13, wherein the dispenser includes a barrel having a first open end and a second open end.

15. The pet food bowl of claim 14, wherein the dispenser includes a first cap couplable to the first open end of the barrel and a second cap couplable to the second open end of the barrel.

16. The pet food bowl of claim 14, wherein an exterior surface of the barrel of the dispenser includes ridges or grooves.

17. The pet food bowl of claim 14, wherein the barrel of the dispenser includes a plurality of openings.

18. The pet food bowl of claim 15, wherein the first cap and the second cap each include a protrusion on an outer surface thereof.

19. The pet food bowl of claim 15, wherein the first cap and the second cap are couplable to the first open end of the barrel and the second open end of the barrel respectively, via a clasp, magnet, or mechanical locking device.

20. The pet food bowl of claim 15, wherein the first cap and the second cap of the dispenser secure the dispenser to the base at the upwardly extending portion of the base.

21. The pet food bowl of claim 18, wherein the upwardly extending portion of the base includes receptacles.

22. The pet food bowl of claim 21, wherein the first cap and the second cap are removably connectable to the receptacles of the upwardly extending portion of the base.

23. The pet food bowl of claim 21, wherein the receptacles of the upwardly extending portion of the base include a locking mechanism to secure the protrusions of the first cap and the second cap to the receptacles.
